(19) United States
(12) Patent Application Publication
(10) Pub. No.: US 2008/0185494 A1
(43) Pub. Date: Aug. 7, 2008

(54) Collapsible Pneumatically Stabilised Support

(76) Inventors: Rolf Luchsinger, Uster (CH); Rene Crettol, Reinach (CH)

Correspondence Address: WINSTEAD PC, P.O. BOX 50784, DALLAS, TX, 75201, US

(21) Appl. No.: 11/885,909

(22) PCT Filed: Mar. 17, 2006
(86) PCT No.: PCT/CH06/00159

§ 371 Date: Apr. 10, 2008

(30) Foreign Application Priority Data
Mar. 23, 2005 (CH) 499/05

(51) Int. Cl. F16M 13/00; E04H 15/20

(52) U.S. Cl. 248/562

(57) ABSTRACT

A collapsible pressure element (2) for pneumatically stabilized supports enables the simple and rapid construction and dismantling thereof. Several pressure segments (4) are located on that side of the pressure element (2) upon which the transversal stress acts, that is, on the side facing away from the hollow body (at the top in the figure). The pressure segments (4) are separated from one another by means of breaks (5). The breaks (5) between the pressure segments (4) permit the pressure element (2) to be collapsed. A tractive element (6) faces the hollow body (at the bottom in the figure), said pressure element (6) being separated from the pressure segments (4) by one or several spacer elements (7).

The present invention relates to pneumatically stabilized supports, which are easy to transport, construct and dismantle, comprising a hollow body as well as pressure and tractive elements according to the preamble of the independent patent claims.

Several pneumatically stabilized components or supports have become known, for example from WO 01/73245 (D1) and from PCT/CH2004/000384 (D2), both from the same applicant as the present invention. If such a support is transversally stressed, the object which is to be solved primarily lies in accommodating the occurring tractive forces and pressure forces, while keeping the support from buckling.

In D1, the axial pressure forces are accommodated by a pressure element, while the axial tractive forces are accommodated by two tractive elements, which are wound around the hollow body in a helical manner and fastened to the ends of the pressure element. The pneumatic element of the supports described in D1 consists of a hollow body, which is supplied with compressed air. Its object primarily lies in stabilizing the pressure elements against buckling.

In D2, the hollow body is substantially shaped like a shaft and the tractive elements are not wound around the hollow body in a helical manner.

For temporary buildings, such as tents or advertising mediums for example, a rapid and uncomplicated construction and dismantling as well as good transportability and small space requirement in the storage are important. The supports disclosed in D1 and D2 have rod-shaped long pressure elements, which are generally separated for transport and storage of the hollow body and the tractive elements.

An integrated solution, where a dismantling of the pressure element and of the tractive elements is not required for the transport, is desirable. It is thereby to be possible for the length of the support, defined by the length of the pressure elements, to be reduced and the support as a whole is to be collapsible or rollable. PCT/CH2004/000111 (D3) shows an integrated solution, where the pressure element together with the emptied hollow body and the tractive elements can be rolled up. Pressure elements according to D3, however, only have a moderate buckling stability. In addition, the use of such pressure elements for supports according to D2 is problematic inasmuch, as several pressure elements are connected with one another at their ends.

D3 represents the closest state of the art.

The object of the instant invention lies in the creation of supports comprising pneumatically supported tractive and pressure elements, which can be collapsed or rolled up for the transport together with pressure and tractive elements and which thus permit a rapid and simple construction and dismantling, respectively.

The solution of the object is expressed in the characterizing part of claim 1 with regard to its essential features and in the following claims with regard to further advantageous developments.

The object of the invention will be explained in more detail on the basis of the enclosed drawings by means of several exemplary embodiments.

FIG. 1 shows a schematic illustration of a pneumatically stabilized support according to the state of the art according to D1 as isometry,

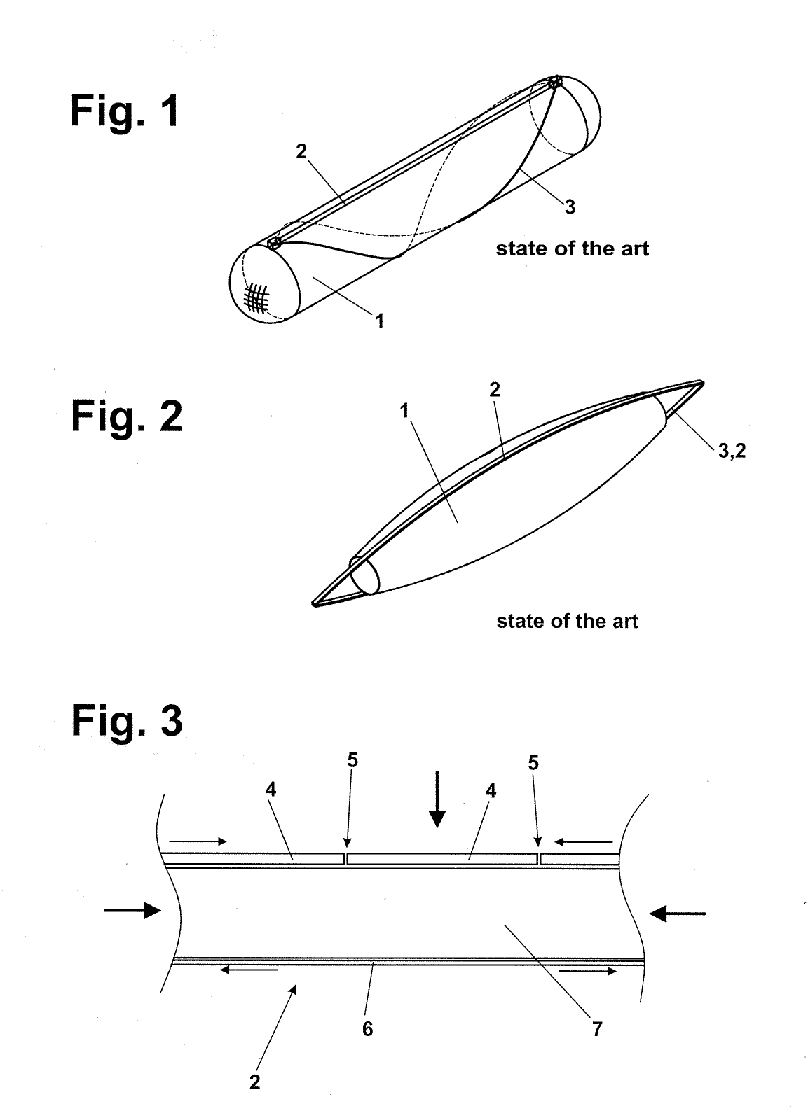

FIG. 2 shows a schematic illustration of a pneumatically stabilized support according to the state of the art according to D2 in side view,

FIG. 3 shows a schematic illustration of the functional principle of collapsible pressure elements as claimed in the invention for pneumatically stabilized supports in a section in side view,

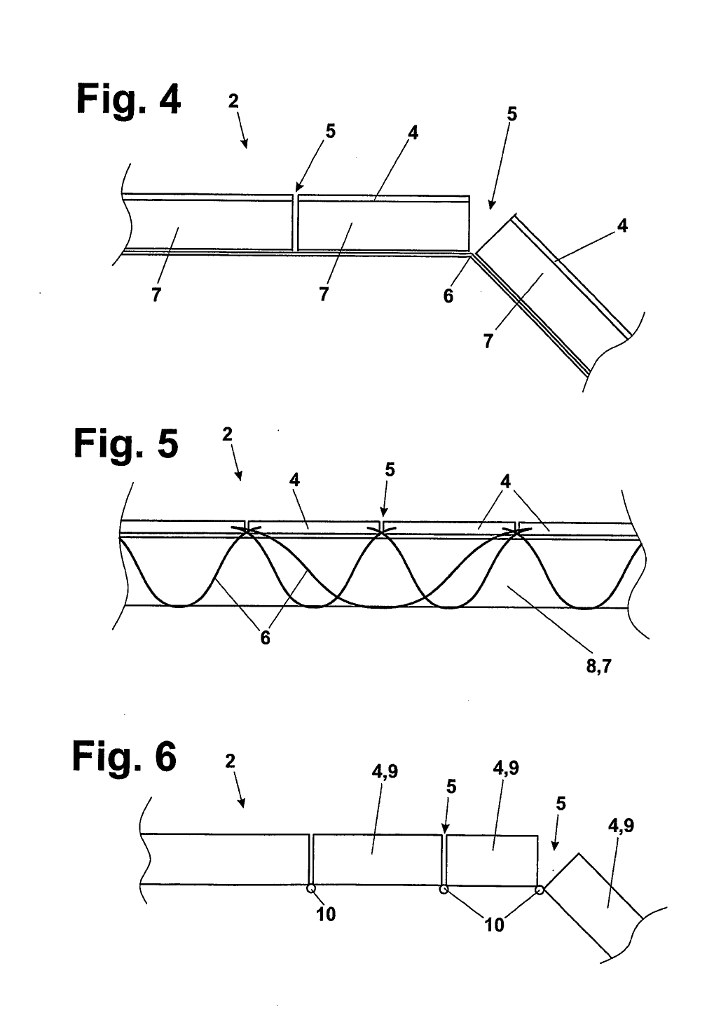

FIG. 4 shows a schematic illustration of a first exemplary embodiment of a collapsible pressure element for pneumatically stabilized supports in a section in side view,

FIG. 5 shows a schematic illustration of a second exemplary embodiment of a collapsible pressure element for pneumatically stabilized supports in a section in side view,

FIG. 6 shows a schematic illustration of a third exemplary embodiment of a collapsible pressure element for pneumatically stabilized supports in a section in side view,

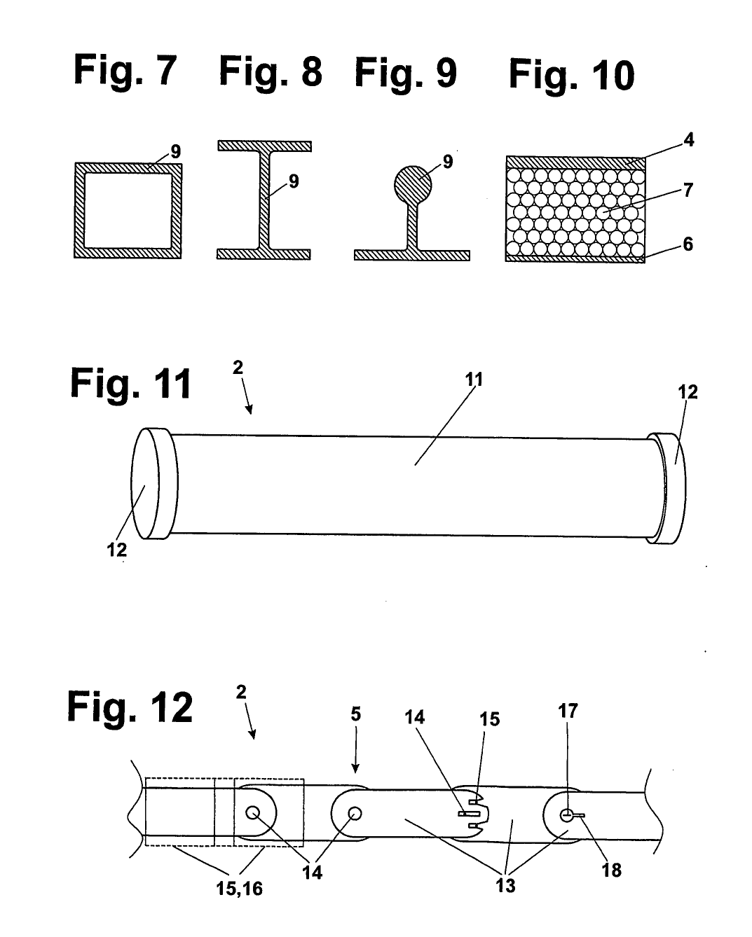

FIGS. 7-10 show schematic illustrations of pressure element cross sections for use in the third exemplary embodiment,

FIG. 11 shows a schematic illustration of a fourth exemplary embodiment of a collapsible pressure element for pneumatically stabilized supports in side view,

FIG. 12 shows a schematic illustration of a fifth exemplary embodiment of a collapsible pressure element for pneumatically stabilized supports in a section in side view,

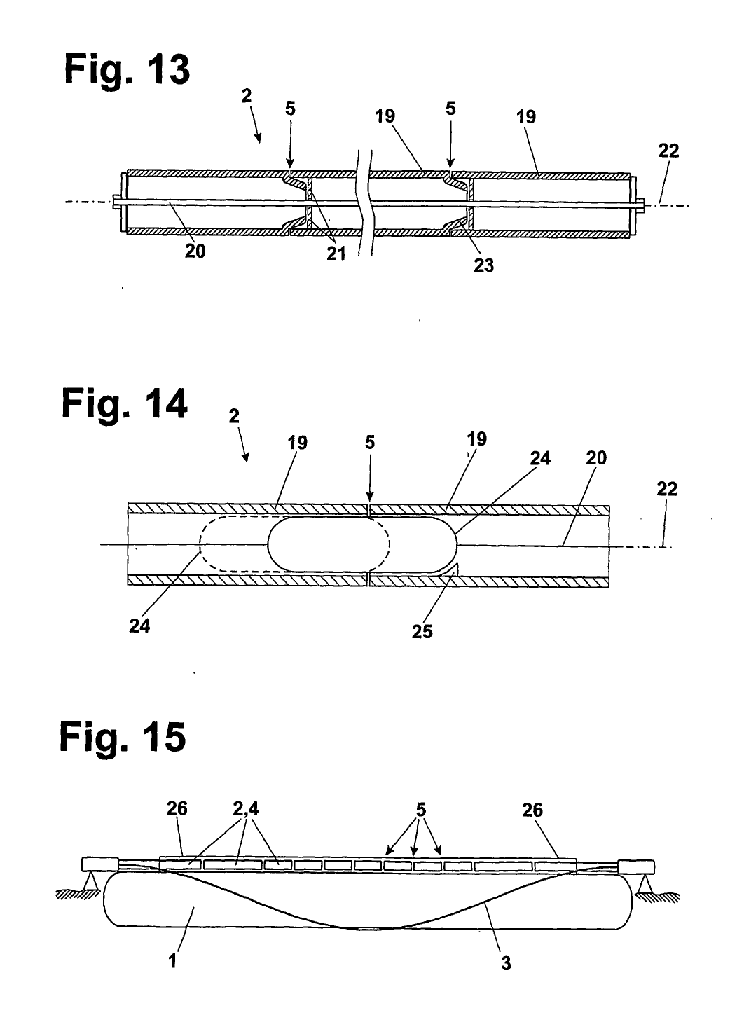

FIG. 13 shows a schematic illustration of a sixth exemplary embodiment of a collapsible pressure element for pneumatically stabilized supports in a section in side view,

FIG. 14 shows a schematic illustration of a seventh exemplary embodiment of a collapsible pressure element for pneumatically stabilized supports in a section in side view,

FIG. 15 shows a schematic illustration of an eighth exemplary embodiment of a collapsible pressure element for pneumatically stabilized supports in side view.

FIGS. 1 and 2 show schematically pneumatically stabilized supports according to the state of the art. FIG. 1 represents a support according to D1. It consists of a cylindrical hollow body 1, a pressure element 2, which is connected with the hollow body 1 substantially across its entire length and two tractive elements 3, which are wound around the hollow body 1 in a helical manner in the opposite direction of rotation. The tractive elements 3 are connected with the ends of the pressure element 2 in a force-fitting manner.

FIG. 2 shows a pneumatically stabilized support according to D2. Provision is again made for a hollow body 1, a pressure element 2 and at least one tractive element 3. The hollow body 1 is shaped like a shaft so that the two ends of the pressure element 2 can be connected with one another by means of the tractive element 3 without being wound around the hollow body 1. In FIG. 2, the tractive element 3 can also be replaced by a pressure element 2, which can accommodate pressure and tractive forces. This support can thus accommodate transversal stresses in positive as well as in negative direction, such as they can arise on roofs, for example, caused by a wind load.

Pressure elements 2 for pneumatically stabilized supports, for example according to D1 or D2, must possess a minimal bending stiffness so that they do not bend locally and thus already break down under the smallest punctiform transversal stresses of the supports, in spite of the stabilization by the hollow body.

To create a pressure element 2, which is as light as possible and yet as buckling-resistant and bending-resistant as possible in transversal stress direction, a function separation can be carried out, similar as with the pneumatically stabilized support according to D1 itself: first of all, one or several elements, pressure segments, accommodate the axial pressure forces. Secondly, one or several elements catch the axial tractive forces. Thirdly, provision must be made for elements, which locally separate the first two elements from one another, which create distance between the local occurrence of pressure and tractive forces and which lend the largest possible transversal installation height and thus bending stiffness to the pressure element 2 with the smallest possible weight gain. In addition, provision must be made for means, which transfer the tractive forces to the pressure segment or to the pressure segments.

All materials, which are suitable for accommodating pressure forces, lend themselves for the production of the pressure segments. Inevitably, such materials or composite materials are firm and can only be bent to a limited extent. To fulfill the demand to ease transportation and storage, the pressure element 2 is also divided into sections of the desired maximum length at the most. The tractive elements can be made of flexible materials or composite materials, which guarantee tensile strength, for example non-metallic straps or ropes. Finally, the spacer element on the one hand can also consist of a firm material—for example of lightwood, foam or a honeycomb structure—and must be, in this case, divided in the same manner as the pressure element. Otherwise, a hollow body, which is supplied with a pressure fluid comprising a flexible sleeve, is used on the other hand as a spacer element. Said hollow body is flexible and collapsible for transport and storage without pressurization.

Some exemplary embodiments of the inventive concept will be schematically illustrated below. The exemplary embodiments can roughly be divided into four types: pressure elements 2, which can be collapsed on one side; pneumatically or hydraulically stabilized pressure elements 2, which can be collapsed on both sides; pressure elements 2, which can be collapsed on both sides and which are stabilized by means of joint adjustments and pressure elements 2, which are collapsible on both sides and which are stabilized by prestress. The above-mentioned function separation can be seen in a more or less clear manner in all of said four types.

FIG. 3 shows schematically a section of a pressure element 2 according to the inventive concept. Several pressure segments 4 are located on that side of the pressure element 2 upon which the transversal stress acts, that is, on the side facing away from the hollow body 1 (always at the top in the following figures). The pressure segments 4 are separated from one another by means of breaks 5. The breaks 5 between the pressure segments 4 permit the pressure element 2 to be collapsed. A tractive element 6 faces the hollow body 1 (always at the bottom in the following figures), said tractive element 6 being separated from the pressure segments 4 by one or several spacer elements 7.

In the support, the pressure element 2 must accommodate pressure forces in axial direction. According to the invention, these pressure forces are substantially accommodated by the pressure segments 4. In cooperation with the tractive element 6, the spacer element 7, with which the pressure segments 4 are connected in a force-fitting manner substantially across their entire length, prevents a buckling of the pressure segments 4, in particular in the region of the breaks 5. In addition, the spacer element 7 ensures an accurate collision of the ends of the pressure segments 4 at said aforementioned breaks 5 and thus a good transfer of the pressure force between adjacent pressure segments 4. Likewise, the tractive element 6 can also be connected with the spacer element 7 in a force-fitting manner across its entire length. In this case, the force transmission between tractive element 6 and pressure segment 4 can occur by means of shear forces via the spacer element 7. However, it is also possible for the tractive element 6 to be connected with the pressure elements 4 in a force-fitting manner only at the ends of the pressure element 2 by means of additional connecting elements. The construction and installation of said connecting elements can be simplified, for example, by narrowing the spacer element 7 towards the ends of the pressure element 2.

If the pressure element 2 is additionally stressed transversally in the direction of the hollow body 1, a tractive force acts in the tractive element 6 and the pressure force in the pressure segments 4 increases. The tractive element 6 is substantially inflexible so that it can accommodate the tractive forces substantially without elongation and so that it can thus counteract a bending or buckling of the pressure element 2.

FIG. 4 shows schematically a section of a first concrete exemplary embodiment of a pressure element 2 according to the inventive concept. The pressure element 2 consists of a network of spacer elements 7 and pressure segments 4, which are divided into sections by means of breaks 5 and which are connected with one another by means of a tractive element 6, which is fastened to the spacer elements 7 across its entire length in a force-fitting manner. The spacer elements 7 can be made of wood, for example; the pressure segments 4 can be made of metal. The cross section of the pressure element 2 is rectangular, for example. The pressure element 2 can be collapsed from the side of the pressure segment 4 in the direction of the tractive element 6 at the breaks 5. In the opposite direction, the pressure element 2 has a high resistance to being bent and can thus withstand punctiform transversal stresses, for which the buckling-stabilizing effect of the hollow body 1 alone would not be sufficient. Said pressure element 2 can only be collapsed or rolled in one direction. When using several pressure elements 2 at a pneumatically stabilized support, provision must thus be made for means, which enable a decoupling and twisting of the pressure elements 2 so that all of the pressure elements 2 can be collapsed or rolled in the same direction.

A section of a second exemplary embodiment of a pressure element 2 as claimed in the invention is represented in FIG. 5. An oblong hollow body 8, which can be supplied with a pressure fluid comprising a flexible sleeve, is present. Said hollow body 8 of the pressure element 2 has a similar function as the large hollow body 1 of the support. While the hollow body 1 stabilizes the pressure element 2 against buckling, the hollow body 8, as spacer element 7, stabilizes the pressure segments 4. As a rule, the hollow body 1 is pressurized with pressures of below 1 bar, depending on its size. However, the pressure of the fluid in the hollow body 8 is greater than 1 bar, for example 8 bar or, if a high-pressure tube is used as a hollow body 8, above 100 bar, for example. As a result of the high pressure, the stabilization against buckling with breaks 5 is clearly increased as compared to the stabilization with the hollow body 1, which is pressurized with a lower pressure. Due to the fact that the hollow body 8 has a comparatively small volume, the use of liquid is not excluded as well, in spite of it being heavier than gas. Liquids, such as water, for example, have the advantage of having only a negligibly small compressibility, which results in a further increase of the buckling stabilizing effect of the hollow body 8. Commercial tubes, for example water tubes or reinforced hydraulic tubes, can be used as hollow body 8, wherein both ends are sealed by means of fasteners. The pressure element 2 has several tractive elements 6, which are guided around the hollow body 8 in pairs in a helical manner in the opposite direction of rotation and the ends of which are fastened to the pressure segments 4. To stabilize the pressure segments 4, provision is made in each case for at least two pairs of tractive elements 6, for example, for each break 5.

FIG. 6 shows schematically a section of a third exemplary embodiment of a pressure element 2. The pressure element 2 consists of at least two sections of a profile 9, which are connected on the side facing the hollow body 1 by means of pivot joints 10.

FIGS. 7-9 show examples for cross sections of the profile 9. The profile 9 can be made from metal or plastic, for example. FIG. 10 shows a cross section through a pressure element 2, which is designed as a sandwich construction, as an alternative to a profile 9. The sandwich construction consists of two metal plates 4, 6, for example, which are separated by means of a honeycomb structure 7. If the pressure element 2 is stressed downwards in FIG. 6, it is bending resistant. The upper region of the profile acts as pressure segment 4, the lower region acts as tractive element 6 and the center region acts as spacer element 7. In the profile 9 in FIG. 7, a box-shaped hollow profile, an upper wall, acts as pressure segment 4, a lower wall acts as tractive element 6 and two lateral walls act as spacer element 7. These profiles can also be designed as a composite. For example, a box-shaped hollow profile made of plastic can be connected on the upper side by means of a steel tape or by means of a metal plate and instead of pivot joints 10, a flexible tractive element 6 can, in turn, be connected with the profiles 9 across the entire length of the pressure element 2. The pivot joint 10 substantially prevents torsion and displacement of the profiles 9, which are strung together. The cross sections of the pressure segments 4 are thus aligned well against one another. In the region of the breaks 5, the pressure segments 4 can be reinforced or the cross section thereof can be increased.

FIG. 11 shows a fourth exemplary embodiment of a collapsible pressure element 2. It is a pneumatic or hydraulic alternative of the solution of the object according to the invention illustrated in FIG. 6. A tube-shaped, pressure-tight hollow body 11 made of flexible material, is pressurized. The cylindrical hollow body 11 assumes the function of the profile 9 in FIG. 6. Due to the fact that the emptied hollow body 11 is flexible, pivot joints 10 can be dispensed with. The hollow body 11 can be reinforced by means of a steel or an aramid netting mesh, for example. It is possible, in turn, to only partially reinforce the hollow body 11, for example on the upper side, which serves as pressure segments 4. Two end pieces 12 close the ends of the tube. The tractive elements 3 can be fastened to these end pieces 12.

FIG. 12 shows schematically a section of a fifth exemplary embodiment of a collapsible pressure element 2. The pressure element 2 consists substantially of a long link chain, the links 13 of which are connected by means of pivot joints 14, such as in a bike chain. This exemplary embodiment has the advantage that it is collapsible on both sides. However, it still requires additional means 15 for temporarily blocking the pivot joints 14. FIG. 12 illustrates schematically, by means of dashed lines, an example for a means 15. Sleeves 16, which are placed over the long link chain, can be pulled over the pivot joints 14 when the links 13 are in an elongate position and thus substantially block a pivoting of the links 13 about the pivot joints 14. The sleeves 16 are connected with one another by means of a cable, for example, and can thus altogether be pulled from a blocking position into a release position via a cable reel. Stops can limit the mobility of the sleeves 16 between these two positions. Another means 15 for blocking the pivot joints 14 when accommodating pressure forces by means of the long link chain is illustrated in FIG. 12 in the right pivot joint 14. The cross section of the axis 17 of the pivot joint 14 is not round but oblong and rectangular and is connected with a link 13 in a force-locking manner so as not to be pivotable. The other link 13 has a round hole, in which the axis 17 can turn. This hole has a funnel-shaped widening comprising a slit 18, wherein the oblong axis 17 fits accurately into the slit 18 and is fixed therein substantially in terms of rotation. Further pins, which retract into further slits 18 in response the chain being pushed together, can still improve the locking of the pivot joint 14. In this case, the cross section of the axis 17 can also be chosen to be round and the axis 17 can be fastened in both links 13, which are connected by the axis, so as to be pivotable. This is shown in FIG. 12 in the second pivot joint 14 from the right.

FIG. 13 shows a section of a sixth exemplary embodiment of a collapsible pressure element 2. The pressure element 2 consists of several hollow profile pieces 19, which can be pressed on top of one another by means of a tightened cable 20. The one cable or several cables 20 can be used for aligning the hollow profile pieces 19 in that guide means 21 hold the cable on the axis 22 of the hollow profile pieces 19, for example. Cone-shaped ends 23 of the hollow profile pieces 19 can additionally support the correct positioning of the hollow profile pieces 19 along an axis 22 when the cable 20 is tightened. Diverse tensioning means, for example cable tighteners, by means of which the cable 20 can be tightened and slackened, are known to the person of skill in the art. The tractive force on the cable 20 counteracts a buckling of the hollow profile pieces 19 in the region of the breaks 5. To collapse the pressure element 2, the cable 20 can be slackened by means of the tensioning means.

In addition, means 15 can impede a buckling of the pressure element 2 in the region of the breaks 5, analogous to the above-mentioned fifth exemplary embodiment.

FIG. 14 shows, in a section of a seventh exemplary embodiment of a pressure element 2, yet a further possibility for the buckling stabilization in the region of the breaks 5 for the sixth exemplary embodiment in FIG. 13. A bolt 24, the outer diameter of which is slightly smaller than the inner diameter of the hollow profile pieces 19, for example tube sections, and the ends of which are cone-shaped or rounded, can be moved in the hollow profile pieces 19 by means of a cable 20. For the buckling stabilization, the bolt 24 is positioned in the hollow profile pieces 19 in such a manner that half of it substantially protrudes into both hollow profile pieces 19. To collapse the pressure element 2, the bolt 24 is pulled into a hollow profile piece 19 either completely or up to its rounded or cone-shaped end. To define these two states, provision is made for stops 25.

Lastly, FIG. 15 shows yet, as eighth exemplary embodiment, a support according to D1 comprising a collapsible pressure element 2, wherein said pressure element 2 consists of several sections, which are separated from one another. The pressure element 2 is formed by several pressure segments 4, which are completely separated from one another and which are inserted into a flexible pocket 26 at the hollow body 1. The pocket 26 is indicated in FIG. 15 only with a dotted line.

Hollow body 1, pressure element 2 and tractive elements 3 are coordinated to one another in such a manner that the tractive elements 3 place the pressure element 2 and, respectively, the pressure segments 4, which are strung together, under compression stress in the event of a pressurization of the hollow body 1.

If the support is stressed, this pressure prestress must first be compensated before tractive forces appear in the pressure element 2. If the loads remain below a critical value, which is defined by the prestress, the pressure segments 4 are always pressed on top of one another at the breaks 5. The pressure element 2 does not buckle, even though is cannot accommodate tractive forces without pressure prestress and even though it is collapsible without any difficulty. The principle corresponds to the exemplary embodiment in FIG. 13, with the difference that an additional cable 20 and tensioning means for tightening said cable 20 are used there for the pressure prestress of the pressure segments 4.

The exemplary embodiments shown in FIGS. 12 to 15 can obviously also be supplemented with a hollow body 8 and tractive elements 6 according to FIG. 5.

Combinations of all of the above-mentioned features of collapsible pressure elements 2, which are not mentioned, can be combined with one another as well and are included in the idea of the invention, although the present document does not explicitly mention all of the alternatives. An exemplary embodiment according to FIG. 6 can, for example, be supplemented with a cable 20 and tensioning means for generating a pressure prestress. This also allows for an installation of the pivot joints 10 at the side of the profile 9, which faces away from the hollow body 1. If the pivot joints 10 are installed at the same pressure element 2 at different sides of the profile 9, the pressure element 2 can be bent multilaterally.

The placement of the breaks 5 can generally occur in freely chosen distances. The sections of the pressure element 2 can have different lengths. At the ends of the pressure element 2, at least one pressure segment 4 is generally chosen to be longer than the remaining pressure segments 4, because the bearing strengths, which act on the pressure element 2 at the ends, increase the buckling tendency for breaks 5.

It is possible to impart a bent shape to the pressure elements 2, for example for pneumatically stabilized supports according to D2.

For the tractive elements 3 to accurately rest against the hollow body 1 when the support is set up, if said hollow body 1 is pressurized, the tractive elements 3 can be positioned in the desired position in a punctiform manner or across the entire length by means of means, which are installed at the hollow body 1, for example pockets or straps. This considerably simplifies the set-up of a collapsed support, because the positioning of the tractive elements 3 and the connection with the pressure element 2 can be dispensed with.

1. A support comprising a hollow body (1), which is supplied with compressed gas, at least one pressure element (2), at least one tractive element (3), wherein the pressure element (2) is stabilized against buckling by means of the hollow body (1) in that said pressure element (2) rests along the hollow body (1) and is connected therewith, characterized in that
the part of the pressure element (2), which accommodates the pressure forces, is divided into several pressure segments (4) by means of breaks (5) and the support can be collapsed or rolled together without dismantling the pressure element (2) after the hollow body (1) has been emptied.

2. The support according to patent claim 1, characterized in that
the pressure element (2) is formed in three layers, at least of one tractive element (6) facing the hollow body (1), of several pressure segments (4) facing away from the hollow body (1) and of at least one spacer element (7), which separates pressure segments (4) and tractive elements (6) from one another.

3. The support according to one of patent claims 1 or 2, characterized in that
provision is made for means for generating a pressure prestress of the pressure element (2) so that the pressure element (2), which is separated by at least one break (5), can be prestressed with pressure force when in an unstressed state.

4. The support according to patent claim 3, characterized in that
the pressure prestress of the pressure element (2) is so high that, even in the event that the support is stressed, the separated pressure element (2) is always pressed together across the entire region of the breaks by means of the pressure prestress.

5. The support according to one of patent claims 3 or 4, characterized in that
the pressure prestress is generated by means of at least one cable (20) and by means of tensioning means.

6. The support according to one of patent claims 3 or 4, characterized in that
the pressure prestress is generated by means of at least one tractive element (3), which is tensioned by a pneumatic hollow body (1).

7. The support according to one of patent claims 1 to 6, characterized in that
the pressure element (2) is divided into several sections, which are connected by means of pivot joints (10, 14) via breaks (5).

8. The support according to patent claim 7, characterized in that
the pivot joints (10) are installed on the side of the pressure element (2) facing the hollow body (1) and that the pressure element (2) can be collapsed, rolled or bent on one side.

9. The support according to patent claim 8, characterized in that
provision is made for means (15) for blocking the pivot joints (10, 14) in the event of an elongate pressure element (2).

10. The support according to patent claim 9, characterized in that
sleeves (16) are used as means (15), which can be positioned above the breaks (5) and which thus block the pivot joints (14).

11. The support according to patent claim 2, characterized in that
an oblong hollow body (8), which can be pressurized in a pneumatic or hydraulic manner, is used as spacer element (7).

12. The support according to patent claim 11, characterized in that
tractive elements (6) in each case connect two pressure segments (4) with one another in pairs, wherein the tractive elements (6) are fastened to the same pressure segments (4) in pairs and are wound around the hollow body (8) in a helical manner in the opposite direction of rotation.

13. The support according to patent claim 2, characterized in that
the spacer element (7) is divided at the breaks (5) and the sections are connected with the pressure segments (4) in a laminar manner.

14. The support according to one of patent claims 1 or 3, characterized in that
the pressure element (2) consists of several hollow profiles (19), which collide at breaks (5) and in that a bolt (24), which substantially accepts the inner cross section of the hollow profile (19), is available for each break (5) and in that furthermore provision is made for means for moving the bolt (24) to the location of the break (5) in the event of an elongate state of the pressure element (2) within the hollow profiles (19) and to thus prevent the pressure element (2) from buckling.

15. A support comprising a hollow body (1), which is supplied with compressed gas, at least one pressure element (2), at least one tractive element (3), wherein the pressure element (2) is stabilized against buckling by means of the hollow body (1) in that said pressure element (2) is connected with the hollow body (1) substantially along its entire length, characterized in that
the pressure element (2) consists of a tube-shaped, pressure-tight hollow body (11), which is made from a flexible material, wherein the pressure in the hollow body (11) is greater than in the hollow body (1) and the pressure fluid in the hollow body (11) is liquid or gaseous.

16. The support according to patent claim 15, characterized in that
the pressure in the hollow body (11) is at least 1 bar.

17. The support according to one of patent claims 1 to 16, characterized in that
provision is made for means, which maintain the position of the tractive elements (3) at the hollow body (11) in the emptied state.
